(19) United States
(12) Patent Application Publication
(10) Pub. No.: US 2023/0042507 A1
(43) Pub. Date: Feb. 9, 2023

(54) FASTENING DEVICE FOR FILL LEVEL GAUGES

(71) Applicant: Endress+Hauser SE+Co. KG, Maulburg (DE)

(72) Inventors: Rolf Schwald, Schopfheim (DE); Manuel Sautermeister, Schopfheim (DE); Andreas Kaiser, Kaisten AG (CH); Ronny Hoffmann, Winterthur (CH)

(21) Appl. No.: 17/758,823

(22) PCT Filed: Dec. 10, 2020
(86) PCT No.: PCT/EP2020/085545

§ 371 Date: Jul. 14, 2022

(30) Foreign Application Priority Data
Jan. 15, 2020 (DE) 10 2020 100 867.8

(51) Int. Cl. G01F 23/284

(52) U.S. Cl. CPC G01F 23/284

(57) ABSTRACT

The present disclosure relates to a fastening device for fixing a radar-based fill level gauge to an outer grating of an intermediate bulk container tank. The device comprises a clamping retainer, which can be clamped to a grating bar of the outer grating, and an adapter having a first fastener configured such that the fill level gauge can be mounted detachably on the adapter. The adapter also includes a cut-out, through which radar signals of the fill level gauge can be sent towards the filling material when in the mounted state. In addition, the device comprises a second fastener configured such that the fill level gauge can be fastened indirectly to the clamping retainer. According to the present disclosure, the outer grating is used to fasten the fill level gauge to the container.

The invention relates to a fastening device for fill-level measuring devices on IBC tanks.

In automation technology, especially for process automation, field devices are often used, which serve to detect various measured variables. The measured variable to be determined may, for example, be a fill level, a flow, a pressure, the temperature, the pH value, the redox potential, a conductivity, or the dielectric value of a medium in a process plant. In order to detect the corresponding measured values, the field devices each comprise suitable sensors or are based on suitable measuring principles. A variety of such types of field devices is produced and marketed by the Endress+Hauser group of companies.

For measuring the fill level of filling materials in containers, radar-based measuring methods have become established since they are robust and require minimum maintenance. A key advantage of radar-based measuring methods lies in the ability to measure the fill level quasi-continuously. In the context of this patent application, the term "radar" refers to radar signals having frequencies between 0.03 GHz and 300 GHz. Typical frequency bands at which fill level measurement is performed are at 2 GHz, 26 GHz, 79 GHz or 120 GHz. The two common measuring principles here are the pulse time-of-flight principle (also known under the term "pulse radar") and the FMCW ("frequency-modulated continuous wave") principle. A fill-level measuring device which operates according to the pulse time-of-flight method is described, for example, in published patent application DE 10 2012 104 858 A1. For a typical construction of FMCW-based fill-level measuring devices, reference is made by way of example to published patent application DE 10 2012 104 858 A1.

In addition, the measuring principles of FMCW and pulse radar are described in more detail in "Radar Level Detection, Peter Devine, 2000," for example.

Fill-level measuring devices are used predominantly on containers which have a corresponding container opening, such as a flange connection on the upper side of the container. In addition, radar-based fill-level measuring devices can, however, in principle also be used on containers without a container opening provided for this purpose, provided that the container wall is transparent to a predominant proportion for the corresponding radar frequencies. This is the case for many plastics-based container types, such as IBC ("intermediate bulk container") tanks. However, in these cases it is not possible to fix the fill-level measuring device to the opening or to the container. The subsequent application of fasteners for the fill-level measuring device in turn entails the risk of reducing the leakproofness of the container, for example by boreholes. Although it is also conceivable to glue the fill-level measuring device to the outer surface of the container, this type of fastening is not readily detachable.

The invention is therefore based on the object of providing a fastening device for detachably fixing a radar-based fill-level measuring device to a container which has no container opening provided for this purpose.

The invention achieves this object using a fastening device for fixing a radar-based fill-level measuring device to an outer grating of a container, especially of a plastics-based IBC tank, comprising:
a clamping retainer which can be clamped to an especially vertical grating bar of the outer grating,
an adapter having
   a first fastener, by means of which the fill-level measuring device can be detachably mounted on the adapter, and
   a cut-out through which, in the mounted state, radar signals of the fill-level measuring device are can be sent toward the filling material and received from there when in the mounted state, and
a second fastener by means of which the fill-level measuring device can be fastened to the clamping retainer via the adapter.

The clamping retainer can be realized, for example, comprising the following components:
a base body having an indentation,
a counter plate, and
a screw connection by means of which a grating bar of the outer grating can be clamped between the counter plate and the indentation.

According to the invention, the outer grating of the container is thus used to secure the fill-level measuring device. As a result, the actual container does not have to be brought into contact with the fill-level measuring device or with the fastening device. This eliminates the need for corresponding structural interventions on the container which, in case of doubt, could adversely affect the leakproofness of the container. The materials from which the clamping retainer and the adapter are each manufactured are not fixedly prescribed within the scope of the invention. What is essential is just that a sufficient rigidity is ensured to be able to carry the fill-level measuring device. Accordingly, the clamping retainer and/or the adapter can be made, for example, of a metal or a mechanically stable plastics material such as PP or PEEK.

The second fastener can preferably be designed such that the fill-level measuring device can be pivoted relative to the outer grating about a defined axis. In this way, a perpendicular orientation of the fill-level measuring device is ensured even in the case of an obliquely extending grating bar. It is also advantageous if the indentation in the clamping retainer has a triangular cross section for the grating bar to be clamped. This offers the advantage that the clamping retainer can be fixed to grating bars of different thicknesses. In order for the fill-level measuring device to be mountable on the fastening device without a tool, it is again advantageous if the first fastener is designed such that the fill-level measuring device can be latched into the adapter.

The fastening device can also be expanded such that the clamping retainer comprises a shim which can be clamped between the counter plate and the indentation by means of the screw connection. This serves to cover the indentation, so that the clamping retainer can also be attached to any outer gratings, the gratings of which are very fine-meshed, with thicknesses of much less than 0.5 cm.

In an analogous manner to the fastening device according to the invention, the object of the invention is also achieved by a corresponding measuring system for measuring a fill level of a filling material located in a container, in which the container has an outer grating. The measuring system comprises the following components:
a radar-based fill-level measuring device, and
a fastening device according to any of the previously described embodiment variants, by means of which the fill-level measuring device can be fixed to the outer grating of the container.

A corresponding method for assembling this measuring system on a container which has an outer grating can therefore be carried out as follows:
clamping the clamping retainer to a grating bar of the outer grating,
attaching the fill-level measuring device to the adapter, and
fastening the adapter together with the fill-level measuring device to the clamping retainer.

The invention is explained in more detail with reference to the following figures. The following is shown:

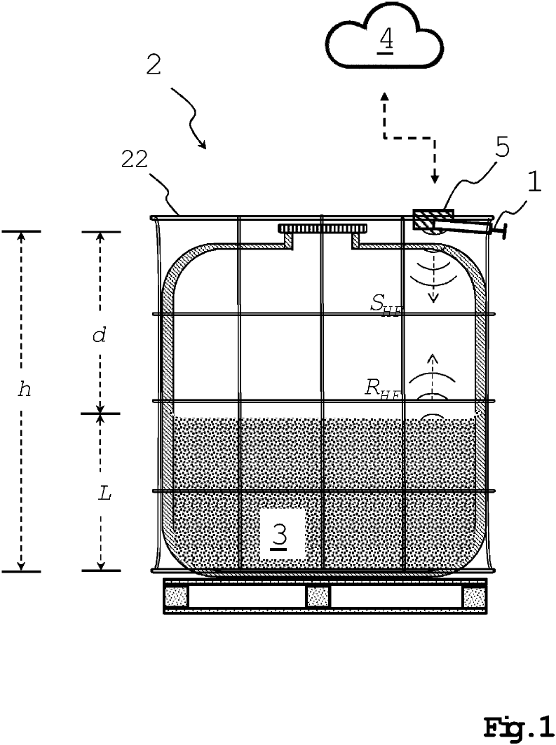

FIG. 1: a fastening, according to the invention, of a radar-based fill-level measuring device to a container,

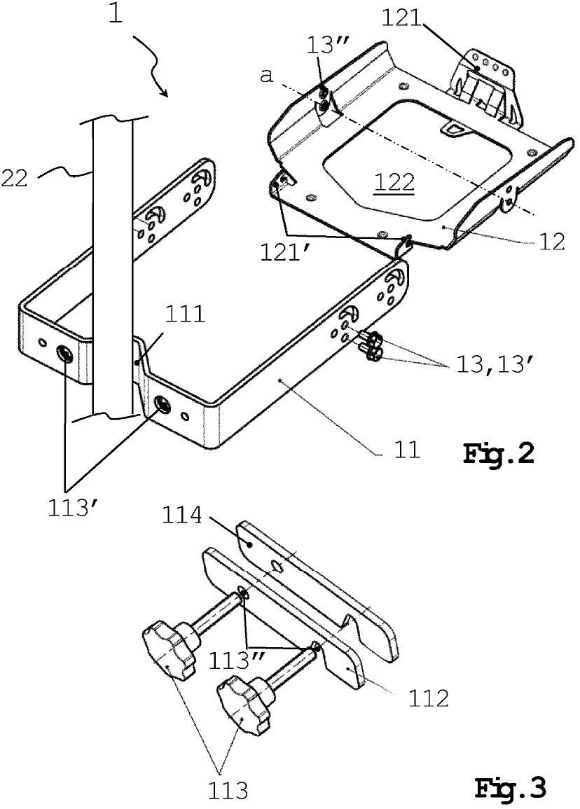

FIG. 2: a detail view of the fastening device according to the invention, and

FIG. 3: a possible implementation form of the clamping retainer.

For a basic understanding of the invention, FIG. 1 shows a freely radiating, radar-based fill-level measuring device 5 on a container 2. A filling material 3, whose fill level L is to be determined by the fill-level measuring device 5, is located in the container 2.

As a rule, the fill-level measuring device 5 is connected via a bus system, such as "Ethernet," "PROFIBUS," "HART," or "Wireless HART," to a superordinate unit 4, such as a process control system or a decentralized database. On the one hand, information about the operating status of the fill-level measuring device 5 can thus be communicated. On the other hand, information about the fill level L can also be transmitted via the bus system in order to control any inflows or outflows that may be present at the container 2.

To determine the fill level L, the fill-level measuring device 5 is mounted above the container 2. Regardless of the measuring principle implemented, the fill-level measuring device 5 is oriented such that a corresponding radar signal S_{HF} is emitted in the direction of the filling material 3 according to the FMCW principle or the pulse time-of-flight principle. The radar signal S_{HF} is reflected at the surface of the filling material 3 and, after a corresponding signal time-of-flight, is correspondingly received from the fill-level measuring device 5 as a received signal R_{HF}. The signal time-of-flight of the radar signal S_{HF}, R_{HF} depends on the distance d = h - L of the fill-level measuring device 5 from the filling material surface.

Because the container 2 illustrated in FIG. 1 is an IBC tank, which does not comprise a separate opening for the fill-level measuring device 5 at the upper container wall, there is no possibility for directly fastening the fill-level measuring device 5 to the container 2. According to the invention, the fill-level measuring device 5 is therefore connected by means of a fastening device 1 to an outer grating 22 of the IBC tank 2.

A detail view of the fastening device 1 according to the invention is shown in more detail in FIG. 2: As can be seen, the fastening device 1 is based on a clamping retainer 11, which can be clamped to one of the grating bars of the outer grating 22. For this purpose, the clamping retainer 11 is based on a strip-shaped base body made of a stainless steel which is bent to form an open rectangle and has the corresponding stiffness for bearing the load of the fill-level measuring device 5. In the center of that side face of the rectangle which lies opposite the open side face, the strip-shaped base body is turned in in the form of an indentation 111, wherein the indentation 111 in the exemplary embodiment shown has a triangular cross section. The triangular indentation 111 serves as a cut-out for that region of the grating bar to which the fill-level measuring device 5 is to be fixed. The triangular cross section makes it possible here for the clamping retainer 11 to be flexible with respect to the grating bar diameter at least within a certain range of values.

The clamping of the grating bar in the indentation 111 is accomplished by means of a counter plate 112 (see FIG. 3), which, in the region of the indentation 111, is pressed against the strip-shaped base body of the clamping retainer 11 by means of a screw connection 113, 113', 113". On the right and left next to the indentation 111, the base body comprises for this purpose one thread 113' each, their distance from one another corresponding to the corresponding leadthroughs 113" in the counter plate 112. By tightening the two corresponding screws 113, the grating bar can be correspondingly clamped in the indentation 111 by the counter plate 113, so that the clamping retainer 11 is fixed to the outer grating 22 of the container 2.

In the embodiment of the screw connection 113, 113', 113" shown in FIG. 3, a shim 114 is also shown as an extended embodiment option, which shim is provided between the counter plate 112 and the indentation 111. Corresponding to the leadthroughs 113" in the counter plate 112, the shim 114 also comprises corresponding leadthroughs, so that the shim 114 can be clamped between the counter plate 112 and the indentation 111 by means of the screw connection 113. This extension can be used when the clamping retainer 11, and thus the fill-level measuring device 5, is not to be attached to grating bars having diameters in the cm region, but also to any outer gratings 22 of the container 2, the gratings of which are very fine-meshed with thicknesses of less than 0.5 cm.

The fill-level measuring device 5 is mounted on the clamping retainer 11, not directly, but via an adapter 12. Accordingly, the adapter 12 for detachable mounting of the fill-level measuring device 5 comprises a first fastener 121, 121'. In the design of the adapter 12, it is essential that the radar signals S_{HF}, R_{HF} are not screened by the adapter 12 when in the mounted state. The embodiment of the adapter 12 shown in FIG. 2 therefore comprises a corresponding cut-out 122 in a base plate. As a result, the radar signals S_{HF}, R_{HF} can be emitted toward the filling material 2 without dimming when in the assembled state of the fill-level measuring device 5 or be received again from there. The base plate or the adapter 12 can also be manufactured from a stainless steel.

As shown in FIG. 2, the first fastener 121, 121' can be designed, for example, in such a way that the fill-level measuring device 5 can be latched into the adapter 12, or vice versa. As a result, the fill-level measuring device 5 can be mounted on the fastening device without a tool. For this purpose, in the exemplary embodiment shown in FIG. 2, two latching hooks 121' for corresponding eyelets on the fill-level measuring device 5 are attached to that end region of the adapter base plate which faces the clamping retainer 11 in the mounted state. At the opposite end region of the adapter base plate, which faces away from the clamping retainer 11 in the mounted state, a latching claw 121 for latching into a corresponding strip is attached to the fill-level measuring device 5. In order to detach the fill-level measuring device 5 from the adapter 12, the latching claw 121 is designed to be outwardly resilient.

The fastening of the adapter 12 or of the fill-level measuring device 5 on the clamping retainer 11 takes place by means of a corresponding second fastener 13, 13', 13". In the embodiment variant shown in FIG. 2, the second fastener 13, 13', 13" is realized in the form of a screw connection. For this purpose, the two side faces on the rectangular, strip-shaped base body of the clamping retainer 11, which are opposite the open side face, each comprise two leadthroughs 13' for four corresponding screws 13. Corresponding to these leadthroughs 13', the adapter 12 comprises corresponding threads 13" on two opposite bends of the base plate.

In the embodiment of the fastener 13 shown in FIG. 2, the upper through-hole of the two through-holes is designed in the shape of a 90° circular segment for each side face. As a result, the fill-level measuring device 5 is pivotable up to 90° in relation to the clamping retainer 11 or to the outer grating 22 about the axis a in which the lower two screws 13 are arranged on the side faces. A perpendicular orientation of the fill-level measuring device 5 is thus ensured even when the respective grating bar segment is inclined.

### LIST OF REFERENCE SIGNS

1 Fastening device
2 Filling material
3 IBC tank
4 Superordinate unit
5 Fill-level measuring device
11 Clamping retainer
12 Adapter
13, 13', 13" Second fastener
22 Outer grating of the IBC tank
111 Indentation
112 Counter plate
113, 113', 113" Screw connection
114 Shim
121, 121' First fastener
a Axis
d Distance
R_{HF} Received radar signal
h Installation height
L Fill level
S_{HF} Radar signal

1-8. (canceled)

9. A fastening device for fixing a radar-based fill-level measuring device to an outer grating of a container, comprising:
a clamping retainer configured to clamp to a grating bar of the outer grating,
an adapter, having
a first fastener configured to detachably mount the fill-level measuring device on the adapter, and
a cut-out through which radar signals of the fill-level measuring device can be sent toward the filling material and received from the filling material when in the mounted state, and
a second fastener configured to fasten the fill-level measuring device to the clamping retainer via the adapter.

10. The fastening device according to claim 9, wherein the second fastener is configured such that the fill-level measuring device can be pivoted relative to the outer grating about a defined axis.

11. The fastening device according to claim 9, wherein the clamping retainer comprises the following components:
a base body having an indentation,
a counter plate,
a screw connection, configured to clamp a grating bar of the outer grating between the counter plate and the indentation.

12. The fastening device according to claim 11, wherein the indentation has a triangular cross section.

13. The fastening device according to claim 12, wherein the clamping retainer comprises a shim, wherein the shim is clamped between the counter plate and the indentation using the screw connection.

14. The fastening device of claim 9, wherein the first fastener is configured such that the fill-level measuring device can be latched into the adapter.

15. A measurement system for measuring a fill level of a filling material located in a container, wherein the container has an outer grating, comprising the following components:
a radar-based fill-level measuring device, and
a fastening device for fixing the fill-level measuring device to the outer grating of the container, wherein the fastening device includes:
a clamping retainer configured to clamp to a grating bar of the outer grating,
an adapter, having
a first fastener configured to detachably mount the fill-level measuring device on the adapter, and
a cut-out through which radar signals of the fill-level measuring device can be sent toward the filling material and received from the filling material when in the mounted state, and
a second fastener configured to fasten the fill-level measuring device to the clamping retainer via the adapter.

16. A method for assembling the measurement system of claim 15 on a container which has an outer grating, the method comprising the following method steps:
clamping the clamping retainer to the grating bar of the outer grating,
fastening the fill-level measuring device to the adapter, and
fastening the adapter together with the fill-level measuring device to the clamping retainer.
